(19) United States
(12) Patent Application Publication
(10) Pub. No.: US 2015/0066570 A1
(43) Pub. Date: Mar. 5, 2015

(54) SYSTEM FOR SELF-MANAGED INVENTORY, SUPPLY CHAIN DYNAMIC SKU PERFORMANCE AND OPTIMIZATION

(71) Applicant: Interstate Batteries, Inc., Dallas, TX (US)

(72) Inventors: Bruce Hellen, Woodinville, WA (US); Joseph T. Mills, Richardson, TX (US); Chris Patton, Frisco, TX (US); Ralph Jurgen Mauelshagen, The Colony, TX (US)

(21) Appl. No.: 14/473,829

(22) Filed: Aug. 29, 2014

Related U.S. Application Data
(60) Provisional application No. 61/871,555, filed on Aug. 29, 2013.

(51) Int. Cl. G06Q 10/06; G06Q 10/08

(52) U.S. Cl. CPC G06Q 10/06315; G06Q 10/087
USPC 705/7.25

(57) ABSTRACT

A self-managed inventory, supply chain dynamic SKU performance and optimization system may be provided. Service trigger generation may monitor the inventory status and direct when service should occur at a dealer location based on market demand. Demand based service may generate a service trigger when the dealer's inventory level reaches a service threshold. Enhanced SKU depth optimization may be employed to provide SKU depth recommendations based upon how product is moving in the market place to ensure that demand based service is reaching a service trigger at a desired service interval. Enhanced SKU depth optimization may be combined with at least one service trigger including a demand trigger to create demand based service, a route trigger to create enhanced route service, and an order trigger to create enhanced order service.

### CROSS-REFERENCE TO RELATED APPLICATION

This application claims the benefit under 35 U.S.C. §119(e) of U.S. Provisional Patent Application Ser. No. 61/871,555 filed on Aug. 29, 2013, entitled “System for Self-Managed Inventory, Supply Chain Dynamic SKU Performance and Optimization,” which is incorporated by reference in its entirety.

### FIELD OF THE DISCLOSURE

The present disclosure generally relates to inventory supply, and more particularly to self-managed inventory, supply chain dynamic SKU performance and optimization.

### BACKGROUND

In the past, a supplier (such as distributor) has used several types of service trigger generators to initiate service to a customer (such as a dealer). In a route trigger, the customer may be on a scheduled route to be completed by the supplier on a specific day of a given week or month. In an order trigger, the customer may initiate a service request by submitting a purchase order to the supplier. In each instance, inventory levels would not be methodically adjusted based upon market conditions, and it may be unclear whether the customer will have sufficient inventory before the next scheduled service event given the service interval.

### SUMMARY

Embodiments of the present disclosure may provide a self-managed inventory, supply chain dynamic SKU performance and optimization method that includes using an information technology system including at least one processor and at least one database, the information technology system communicating with a dealer location over a communications network, defining a service threshold associated with at least one stock keeping unit (SKU) at the dealer location, receiving at least one inventory count data feed from monitoring the at least one SKU at the dealer location over a predefined time interval, processing the at least one inventory count data feed to generate enhanced SKU depth recommendations relative to a service threshold associated with the at least one SKU for the dealer location, and processing a service trigger that directs service to the dealer location when the service threshold is met for the at least one SKU at the dealer location. As one possible data collection method, the monitoring may be performed using radio-frequency identification (RFID) transmitters communicating with the information technology system over the communications network. The service threshold may comprise inventory level, time out of stock, and time period since last servicing event. Enhanced SKU depth recommendations are based upon several factors including but not limited to, the actual rate that a particular SKU is moving at that dealer and seasonality.

Other embodiments of the present disclosure may provide a self-managed inventory, supply chain dynamic SKU performance and optimization system comprising a service trigger generator that monitors at least one stock keeping unit (SKU) at a dealer location and creates a service trigger to direct service to the dealer location when an inventory level associated with the at least one SKU at the dealer location reaches a service threshold. The system also may comprise an enhanced SKU depth optimizer that provides SKU depth recommendations based on changes in the inventory level associated with the at least one SKU monitored over a specified period of time. A service trigger generation system based upon market demand may monitor the inventory status on a rack and direct when service should occur. That is, service should be directed based upon such inputs including but not limited to inventory levels, time out of stock, and time period since last servicing event. These variables collectively define a service threshold for each dealer based upon actual market conditions. Inventory levels, time out of stock and time period since last servicing event should never exceed a service standard for that dealer. While route and order service triggers create route service and order service, using market demand as a service trigger creates demand based service.

Further embodiments of the present disclosure may provide a self-managed inventory, supply chain dynamic SKU performance and optimization system comprising at least one inventory count transmitter sending at least one scheduled data feed about at least one stock keeping unit (SKU) at a dealer location, and an information technology system that processes the at least one scheduled data feed from the at least one inventory count transmitter and provides enhanced SKU depth optimization recommendations based on the processed information. The processed information may comprise inventory movement, inventory history and transmitter characteristics. The information technology system may comprise a recommendations engine containing SKU depth recommendations and at least one service trigger generator. The at least one service trigger generator may be selected from the group comprising: a route trigger generator, an order trigger generator, and a demand based service trigger generator. The at least one service trigger generator may be the demand based service trigger generator based upon reaching a service threshold, and the enhanced SKU depth optimization recommendations may be based a service threshold is reached at a desired service interval. The at least one service trigger generator may be the route trigger generator and the demand based service trigger generator may be used in an auxiliary manner to provide an advisory when out of cycle replenishment is required. Additionally, when a route service trigger generator is employed the enhanced SKU depth optimization recommendations may be utilized to adjust the desired service interval, thus creating enhanced route service. The at least one service trigger generator may be the order trigger generator and the demand based service trigger generator may be used in an auxiliary manner to provide an advisory when out of cycle replenishment may be expected. Additionally, when an order service trigger generator is employed the enhanced SKU depth optimization recommendations may be utilized to adjust the desired service interval, thus creating enhanced order service. The information technology system may comprise at least one database storing one or more tables containing inventory counts, inventory history and transmitter characteristic data obtained from the at least one inventory count transmitter. The information technology system may provide recommendation outputs in the form of secure web services.

### BRIEF DESCRIPTION OF THE DRAWINGS

For a more complete understanding of this disclosure, reference is now made to the following description, taken in conjunction with the accompanying drawings, in which:

FIG. 1 depicts a chart in a threshold model for demand based service according to an embodiment of the present disclosure;

FIG. 2 depicts a sample velocity-based replenishment computation for a predictive model of demand based service according to an embodiment of the present disclosure;

FIG. 3 depicts an enhanced SKU depth optimization methodology according to an embodiment of the present disclosure;

FIG. 4 depicts enhanced SKU depth optimization with different service trigger generators according to an embodiment of the present disclosure; and

FIG. 5 depicts a high-level architectural structure flowing data feeds from various collection sites through an IT system to produce enhanced SKU depth optimization outputs according to an embodiment of the present disclosure.

### DETAILED DESCRIPTION

Embodiments of the present disclosure may provide a self-managed inventory, supply chain dynamic SKU performance and optimization system. Such a system may autonomously monitor inventory status on racks at a dealer's location, direct when service should occur, replenish inventory on demand to ensure dealers always have inventory on hand, and electronically evaluate SKU depth to maximize a dealer's cash flow cycle. For example, service may be directed based upon various inputs including, but not necessarily limited to, inventory levels, time out of stock, and time period since last servicing event. These various inputs may collectively define a service threshold for each dealer based upon actual market conditions. Inventory levels, time out of stock, and time period since last servicing event should never exceed a service standard for that dealer. Using such a system according to embodiments of the present disclosure, inventory management will no longer require continuous resourcing or as much direct effort on the part of the dealer for the supplier to monitor inventory, and the supplier may ensure that inventory for its dealers may be resupplied so that the dealers are less likely to miss sales due to insufficient inventory. Additionally, for dealers that have been placing orders, administrative responsibility for this task may be shifted to the supplier who may now manage inventory levels based upon actual market conditions associated with those dealers.

Inventory monitoring according to embodiments of the present disclosure can occur utilizing many data collection methodologies, including but not limited to an autonomous radio-frequency identification (RFID) system. While route and order service triggers may create route service and order service respectively, using market demand as a service trigger may create demand based service. This may be done through a predictive model (wherein daily inventory counts by SKU can help to predict when inventory will need replenishing and what replenishment quantities are required to keep a SKU in stock for a target time period) and/or a threshold model (which may be based on several inputs including, but not limited to, dealer size, dealer stocking level, minimum rack SKU quantity, and maximum acceptable SKU out of stock time, wherein when the inputs are combined, a chart may be output that defines when the service trigger will be activated).

In an embodiment of the present disclosure, enhanced SKU depth optimization recommendations may be made based upon how product is actually moving in the marketplace. SKU depth recommendations may be evaluated by SKU, by dealer, and/or by day (i.e., identifying optimal inventory levels) on both a short-term and a long-term basis. These SKU depth recommendations may be targeted at ensuring the dealer reaches its service threshold at the desired service interval according to demand based service criteria.

Enhanced SKU depth optimization may be used with route service to extend the service interval and create enhanced route service. This type of service option can be referred to as SmartService Type 1 according to an embodiment of the present disclosure. Dealers may still be replenished according to a predetermined schedule, but SKU depth may be monitored and adjusted according to demand based service criteria to ensure the dealer reaches a service threshold concurrent to when the recurring/scheduled replenishment occurs. Utilizing the demand based service methodology in an auxiliary manner, an advisory may be given when a service threshold is reached, and the supplier may use this advisory as a warning to provide out-of-cycle replenishment when necessary to ensure the dealer has sufficient product on hand.

Enhanced SKU depth optimization may be used with order service to extend the time period between when the dealer needs to order product to create enhanced order service. This type of service option can be referred to as SmartService Type 2 according to an embodiment of the present disclosure. Dealers may still be replenished according to their ordering patterns, but SKU depth may be monitored and adjusted according to demand based service criteria to ensure the dealer reaches a service threshold concurrent to when the supplier desires wants the dealer to place an order. The supplier may use the demand based service methodology in an auxiliary manner to provide an advisory regarding when the service threshold is reached and this advisory can be utilized to prompt the dealer to place an order.

Enhanced SKU depth optimization and demand based service may work together to ensure that the supplier can service its dealers in the most efficient and effective way possible. This type of service option may be referred to as SmartService Type 3 according to an embodiment of the present disclosure. In this embodiment of the present disclosure, the supplier may be advised when a dealer has reached a service threshold. Replenishment should occur, however, before the dealer reaches a service standard. SKU depth recommendations may be made to maximize product flow efficiency and ensure that the dealer is reaching a service threshold at the desired service interval. Monitoring and adjusting SKU depth based upon actual market demand may maximize a dealer's cash flow cycle, minimize waste, reduce overhead, streamline distribution costs, and optimize service.

More specifically, embodiments of the present disclosure may be directed to a type of service trigger option related to demand. Demand based service may provide an electronic solution to help suppliers monitor inventory on the racks at their dealers' places of business. In demand based service, the total inventory present on a rack in a dealer's place of business may be electronically monitored on a regular basis (i.e., may be daily or another time period specified through the system). Replenishment service may be provided so that the dealer may maintain minimum rack SKU quantity (i.e., faster moving SKUs) and maximum acceptable SKU out of stock time (i.e., slower moving SKUs).

Logic may be coded within demand based service to ensure dealers never run out of faster moving SKUs. Regarding slower moving SKUs, it is highly inefficient and largely impractical for a supplier to rush out to a dealer's place of business to replace a slower moving SKU as it is sold, particularly in instances where a dealer may carry only one unit of product having a particular SKU. Accordingly, to strike a balance between minimizing costs and missing sales, demand based service may monitor a dealer's supply and allow that missing product to remain unreplenished for a predetermined amount of time before the system identifies this dealer as needing service (i.e., before the dealer reaches a service threshold).

Minimum rack SKU quantity and maximum acceptable SKU out of stock time may be achieved in several ways, including but not limited to, through frequency of service and/or inventory depth. SmartService Type 3, which utilizes demand based service criteria and enhanced SKU depth optimization, may be considered the most efficient and effective way to resupply dealers. However, it should be appreciated that using demand based service and enhanced SKU depth optimization to resupply dealers may be implemented in other manners without departing from the present disclosure.

In SmartService Type 3, two programs may operate in unison to produce the desired result. First, demand based service may monitor the inventory status on the rack in a dealer's place of business and then direct when service should occur based on such monitoring. Second, enhanced SKU depth optimization may make SKU depth recommendations based upon how product is actually moving in the marketplace (i.e., evaluating factors including, but not limited to, SKU, dealer needs, seasonality, and/or time period). These two components of SmartService Type 3 may work together to ensure suppliers are servicing their dealers in the most efficient and effective manner possible. It should be appreciated that more variables may be incorporated without departing from the present disclosure. RFID inputs may be used to produce actionable information in a user-friendly format that may decrease costs and increase sales for both suppliers and dealers.

Specialized racks may be positioned in a dealer's place of business to hold inventory. Such specialized racks may be configured with technology, such as RFID, to provide the ability to monitor inventory, such as by SKU, by dealer and/or by specified time period. This may provide the best way to monitor inventory on a daily basis. In the past, point of sale (POS) data has been used to manage inventory, but some studies estimate that POS data generally only provides about 65% accuracy for inventory decisions as it may not reflect the reality of the inventory on hand at a given time. If there is a need to know how much inventory is present at a given location, then the most accurate accounting method is to actually count it using an electronic system. As such, a system according to embodiments of the present disclosure allows for inventory to be counted, dependably and often, through monitoring technology, such as RFID.

As previously discussed, in service trigger generation, both predictive and threshold models may be provided for calculating service schedules for demand based service. Each of these models will be described in more detail below.

In a predictive model, daily inventory counts using RFID may enable a supplier to apply advanced inventory analysis techniques to predict when inventory may need replenishing. Each SKU may be evaluated to see how fast it is selling at a dealer's place of business (i.e., SKU velocity). The number of items having that SKU may then be considered to see how many are remaining on the rack, and then a calculation may be made as to when the dealer may require inventory replenishment. It should be appreciated that the dealer stocking level may be variable during each servicing event. The goal is to replenish dealers with the optimal amount of product so the next servicing event is at the desired service interval, resulting in the most effective cadence for suppliers. The date of last service may be tracked to ensure dealers are visited on or before the maximum service interval date (for dealer relations, even if service is not required). Procedures may be put into place to resupply dealers at different stocking levels during each servicing event. Additionally, procedures may be put into place for addressing slow moving SKUs.

In a threshold model, a model utilizing four inputs may be visualized (additional inputs such as seasonality may also apply)—(1) dealer size; (2) dealer stocking level; (3) minimum rack SKU quantity for fast-moving SKUs; and (4) maximum acceptable SKU out of stock time for slow-moving SKUs. With respect to dealer size, dealers may be defined as small, medium or large. With dealer stocking level, stocking levels may be defined as low, intermediate or high. Minimum rack SKU quantity may be defined as the minimum number of faster-moving SKUs that should be kept supplied on a rack. Maximum acceptable SKU out of stock time may be defined as the maximum number of days that a supplier may accept dealers being out of stock for slower-moving SKUs before directing service. Within the threshold model, each SKU may be assigned to one of two possible thresholds: (1) actual SKU quantity on rack (for faster moving SKUs) and (2) time since hitting zero out of stocks (for slower moving SKUs). Combining these four inputs (or more depending upon individual circumstances) may result in a chart that may define when the service trigger will be activated. This chart may be consistent and scalable and may be applicable to all dealers.

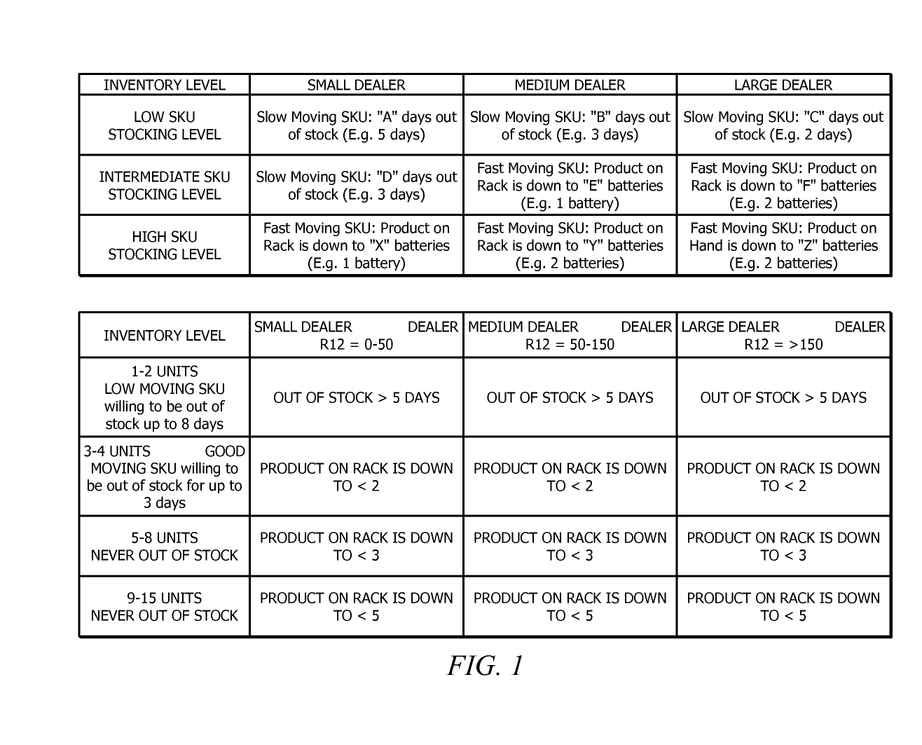

FIG. 1 depicts a chart in a threshold model for demand based service according to an embodiment of the present disclosure. In this embodiment of the present disclosure, an inventory level may be defined as a low SKU stocking level, an intermediate SKU stocking level, or a high SKU stocking level. It should be appreciated that actions taken with respect to low, intermediate and high SKU stocking levels may be different for a small dealer, a medium dealer, and a large dealer according to embodiments of the present disclosure. As depicted in FIG. 1, for a large dealer, a low SKU stocking level may be for a slow moving SKU and may be defined as “C” days out of stock (e.g., 2 days) while an intermediate SKU stocking level for a fast moving SKU for the large dealer may be that the product on rack is down to “F” batteries (e.g., 2 batteries) and a high SKU stocking level for a fast moving SKU may be that product on hand is down to “Z” batteries (e.g., 2 batteries). As depicted in FIG. 1, for a given stocking level, a small dealer may be able to last more days out of stock of a particular item than a medium or large dealer. Also as depicted in FIG. 1, for a given stocking level, the SKU may be associated with a number of days out of stock and/or a number of units without departing from the present disclosure.

Also, as depicted in FIG. 1, if a dealer stocks 1-2 units of a particular SKU, this may be considered a slow moving SKU that a dealer may be willing to have out of stock for up to 8 days, and in this embodiment of the present disclosure, a small, medium or large dealer may be willing to be out of stock of a low moving SKU for more than 5 days. A good moving SKU may be one where a dealer stocks 3-4 units and may be willing to be out of stock of for up to 3 days. In this embodiment of the present disclosure, small, medium and large dealers may set a good moving SKU to be replenished when there are two or fewer units on the rack. Other SKUs may be identified as ones that a dealer never wishes to be out of stock, and the replenishment levels may be set depending on the number of units being stocked. For example, if a dealer typically stocks 5-8 units, then replenishment may be set to occur when the product on the rack is down to less than 3. Similarly, if a dealer typically stocks 9-15 units, replenishment may be set to occur when the product on the rack is down to less than 5, and if more than 15 units are stocked, replenishment may be set to occur when the product on the rack is down to less than 10. However, it should be appreciated that more or fewer inventory levels may be defined without departing from the present disclosure. Similarly, different replenishment levels may be defined for small, medium and large dealers without departing from the present disclosure.

As depicted in FIG. 1, a service threshold would be reached and a service trigger would be generated when a fast moving SKU at a dealer sells down to 3 of these SKUs remaining on hand. In another embodiment of the present disclosure, if a large dealer had a SKU with only 1 as its stocking level, this SKU would be considered to have a low stocking level. Based on FIG. 1, a service trigger may be generated when the SKU has been out of stock for five days.

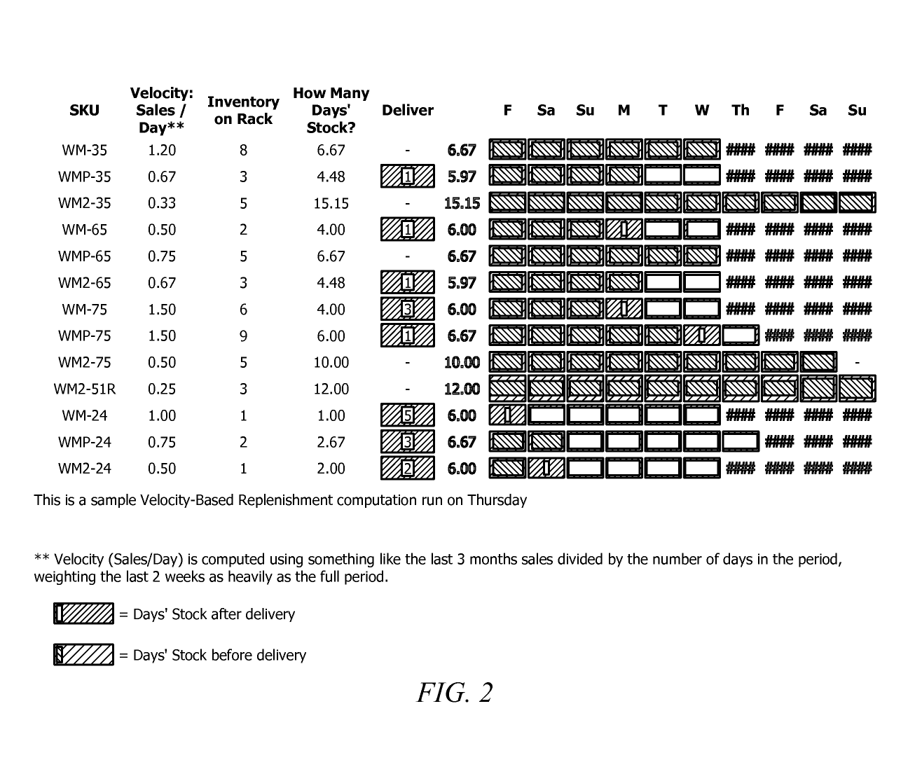

FIG. 2 provides a sample velocity-based replenishment computation for a predictive model of demand based service according to an embodiment of the present disclosure. Velocity (sales/day) may be computed using a certain number of sales over a set period of time (such as the last 3 months of sales) divided by the number of days in the set period, weighting the last part of the period (such as the last 2 weeks) as heavily as the full period. In this example, RFID-read inventory counts may be performed on a Thursday night and then a determination may be made as to how many parts to deliver on Friday. A rack should be stocked in this embodiment so that every SKU should last until Wednesday based on known velocity. By the time that Monday arrives, another read is done in this embodiment and a determination is made that 3-4 SKUs oversold over the weekend and need replenishment. Accordingly, each SKU may aggregate to a demand based service order for that dealer. It also should be appreciated that the planogram minimums may be used to override if needed without departing from the present disclosure.

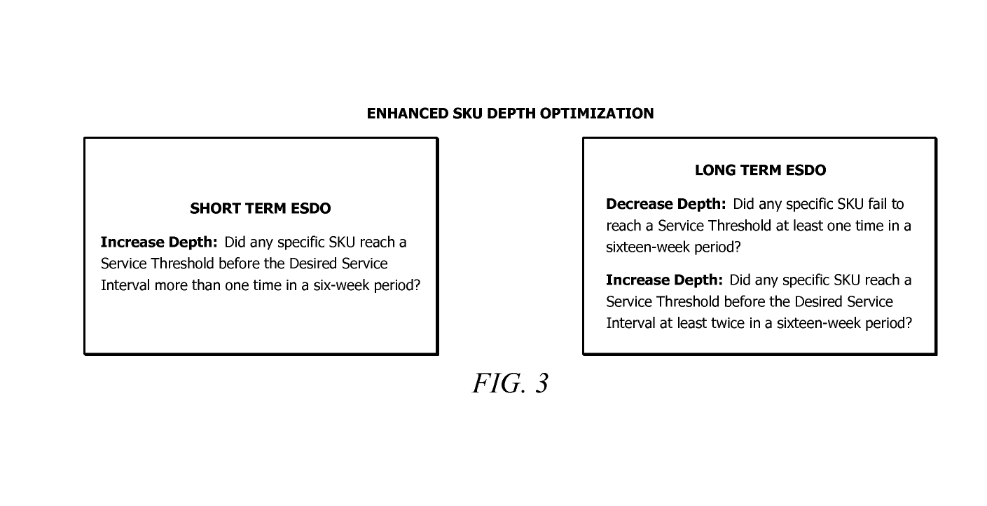

FIG. 3 depicts enhanced SKU depth optimization according to an embodiment of the present disclosure. Enhanced SKU depth optimization may be used to identify the optimal inventory level for one or more SKUs made available for sale by one or more dealers. In embodiments of the present disclosure, two windows of time may be constantly evaluated for each dealer—short-term enhanced SKU depth optimization and long-term enhanced SKU depth optimization.

In short-term enhanced SKU depth optimization according to an embodiment of the present disclosure, in order to increase depth, an evaluation may be made as to whether any specific SKU reached a service threshold before the desired service interval more than one time in a six-week period. With short-term enhanced SKU depth optimization, a six-week period may be analyzed to identify SKUs that may require immediate adjustments to their SKU stocking levels because the dealer is not being serviced at the desired service interval. In an example, a medium-sized dealer may have a desired service interval of every 14 days. Over the past 6 weeks, the dealer's actual average service interval has been every 10 days, and service has been triggered 3 times earlier than the desired service interval due to the dealer running out of a specific SKU. When the dealer is next evaluated, the supplier may suggest that the depth of that SKU should be increased to help stabilize the dealer at the desired service interval. It should be appreciated that the number of times that a service threshold is reached before the desired service interval may be increased without departing from the present disclosure. Similarly, the time period for evaluating the number of times that a service threshold is reached before the desired service interval may be increased or decreased without departing from the present disclosure.

In long-term enhanced SKU depth optimization according to an embodiment of the present disclosure, in order to decrease depth, an evaluation may be made as to whether any specific SKU failed to reach a service threshold at least one time in a sixteen-week period. Conversely, in order to increase depth according to an embodiment of the present disclosure, an evaluation may be made as to whether any specific SKU reached a service threshold before the desired service interval at least twice in a sixteen-week period. In this embodiment of the present disclosure, a specific SKU may be analyzed over the previous 16 weeks and appropriate adjustment recommendations may be made. For example, over a sixteen-week period, the dealer's supply of a specific SKU may never have been depleted low enough to initiate a service trigger. In this circumstance, a recommendation may be made to decrease the depth of this SKU to achieve the optimal inventory level. In another example, a specific SKU may have caused the dealer to reaches a service threshold before the desired service interval twice over a sixteen-week period. This may not be frequent enough to be detected using short-term enhanced SKU depth optimization, but the long-term enhanced SKU depth optimization may advise to increase the depth of that SKU. As discussed with respect to short-term enhanced SKU depth optimization, it should be appreciated that the number of times that a service threshold is reached before the desired service interval may be increased or decreased without departing from the present disclosure. Similarly, the time period for evaluating the number of times that a service threshold is reached before the desired service interval may be increased or decreased without departing from the present disclosure.

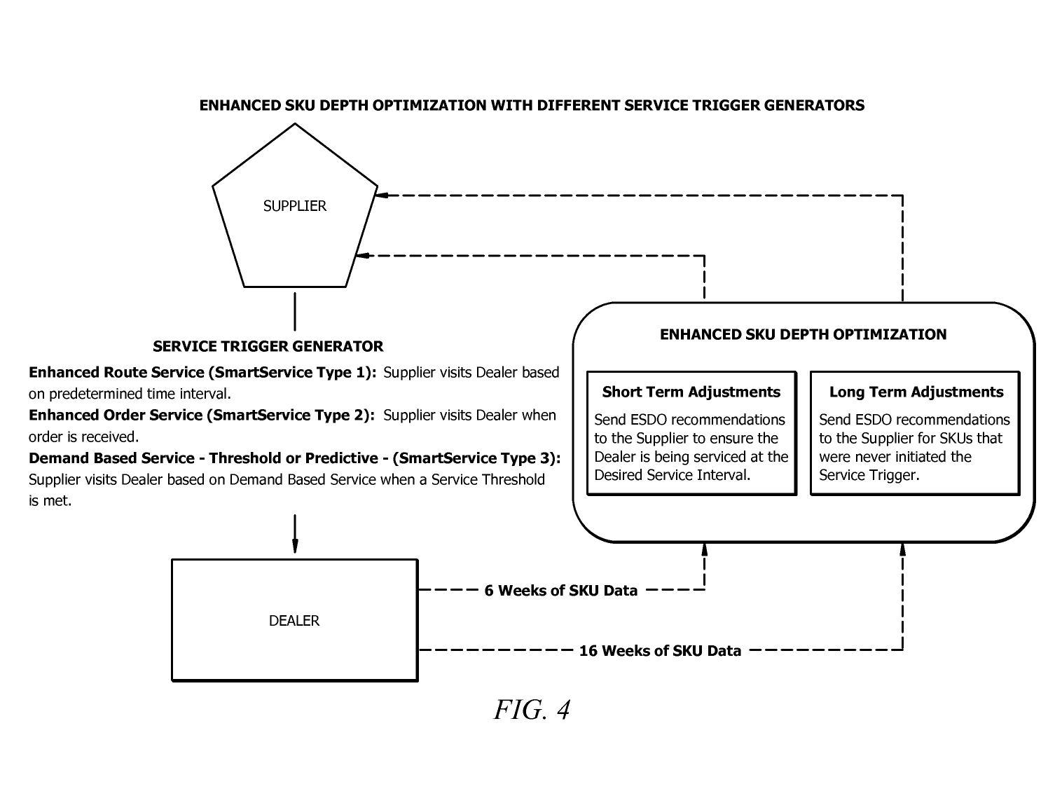

FIG. 4 depicts enhanced SKU depth optimization with different service trigger generators according to an embodiment of the present disclosure. As previously discussed, there may be three types of service trigger generators: route, order and demand, which in turn can lead to SmartService Type 1, SmartService Type 2 and SmartService Type 3. SmartService Type 1 may be considered enhanced route service wherein a supplier visits a dealer based on a predetermined time interval and the interval may be extended beyond normal route service by optimizing the SKU depth to accommodate this increased service interval. SmartService Type 2 may be considered enhanced order service wherein a supplier visits a dealer when an order is received but the targeted time between orders may be increased by optimizing the SKU depth to accommodate this additional time period. SmartService Type 3 may be considered demand based service, whether threshold or predictive, and in SmartService Type 3, a supplier visits a dealer when a service threshold is met.

In this embodiment of the present disclosure, a dealer may provide six weeks of SKU data to initiate short-term adjustments, meaning that enhanced SKU depth optimization recommendations may be sent to the supplier to ensure that a dealer is being serviced at a desired service interval. A dealer may provide sixteen weeks of SKU data to initiate long-term adjustments, meaning that enhanced SKU depth optimization recommendations may be sent to the supplier for SKUs that have not initiated a service trigger during that time period. Again, it should be appreciated that the amount of SKU data and the time period over which SKU data is provided may be increased or decreased without departing from the present disclosure.

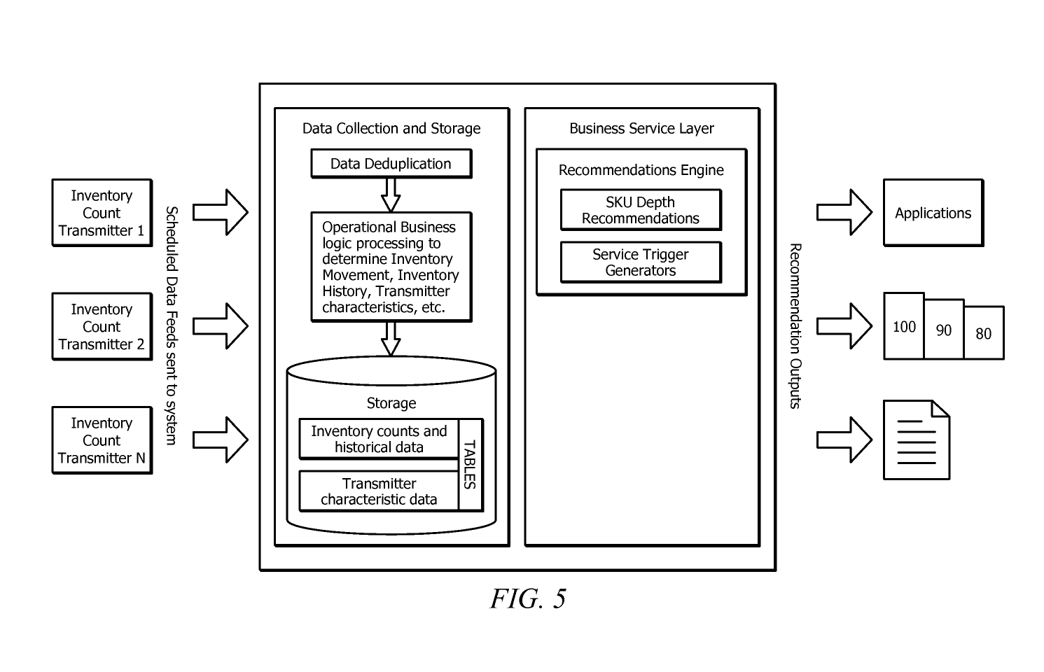

FIG. 5 depicts a high-level architectural structure flowing data feeds from various collection sites through an IT system to produce enhanced SKU depth optimization outputs according to an embodiment of the present disclosure. It should be appreciated that different architectures for providing demand based service and enhanced SKU depth optimization may be provided without departing from the present disclosure. Embodiments of the present disclosure may provide an IT system containing at least one server system and at least one database for storage of information received from one or more inputs. It should be appreciated that the at least one server system may be hosted on premises or may be cloud-based without departing from the present disclosure. The at least one server system may include load-balanced servers to provide horizontal scalability according to embodiments of the present disclosure. It also should be appreciated that the at least one database may have large storage capacity depending on the amount of information to be stored.

One or more external collection points, identified in FIG. 5 as inventory count transmitters 1, 2, N, may be scheduled to provide data feeds to an IT system. It should be appreciated that inventory count transmitters 1, 2, N may be scheduled to provide data feeds to the IT system at different time intervals without departing from the present disclosure. In an embodiment of the present disclosure, inventory count transmitters may be RFID transmitters; however, other mechanisms for transmission of inventory count information may be used without departing from the present disclosure.

The IT system may include demand based service and service trigger generator logic platforms according to embodiments of the present disclosure. In this embodiment of the present disclosure, data collection and storage may be provided within the IT system. More specifically, data feeds received from inventory count transmitters 1, 2, N may undergo data de-duplication followed by operational business logic processing to make various determinations including, but not limited to, inventory movement, inventory history and transmitter characteristics, and then the processed data may be stored in one or more databases. Storage may be provided in one or more tables based on the type of determination made in the processing step. For example, FIG. 5 depicts that one or more tables may be stored reflecting inventory counts and historical data while one or more tables may be stored reflecting transmitter characteristic data. It should be appreciated that there may be more or fewer tables stored without departing from the present disclosure. Similarly, it should be appreciated that tables may be stored in the same database or in different databases without departing from the present disclosure.

The IT system also may include a business service layer according to an embodiment of the present disclosure. This business service layer may include a recommendations engine that may generate SKU Depth recommendations and/or service trigger generators according to embodiments of the present disclosure. The business server layer may run on one or more servers which may be hosted on-premises or may be cloud-based according to embodiments of the present disclosure. Data may be fed to the business service layer from a table structure or a web service according to embodiments of the present disclosure.

Recommendation outputs may then be transmitted by the IT system in one or more formats to ultimately produce directions for SmartService. FIG. 5 depicts that recommendation outputs may take the form of raw data recommendations via secure web services for processing downstream analytical and operational systems and applications according to an embodiment of the present disclosure. However, it should be appreciated that other outputs may be provided without departing from the present disclosure.

Embodiments of the present disclosure may allow for planograms to be established for each dealer, the depth being based on how frequently the supplier may wish to service the dealer. A baseline for how often service is provided may be established according to embodiments of the present disclosure. Racks containing the monitoring technology, such as RFID, may then be placed in the dealers' respective places of business sufficient enough to handle the planogram. Primary and secondary restocking schedules may be established according to embodiments of the present disclosure. Embodiments of the present disclosure also may provide for different levels of inventory to be provided (i.e., small replenishment or full replenishment). Utilizing variable replenishment levels is potentially applicable to all service methodologies, but lends itself most prevalently to the predictive model of demand based service.

Embodiments of the present disclosure may be used by various types of suppliers to manage supply chains and inventories to multiple types of dealers (utilizing specially designed racks to monitor the inventory negates the reliance upon point of sale information and provides the most accurate foundational data for the service trigger calculations). It should be appreciated that a dealer's supply may be replenished over a time period as specified by the dealer, and the amount of inventory that may be supplied is only limited by size of the racks being monitored by the system according to embodiments of the present disclosure.

Although the present disclosure and its advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure, processes, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

1. A self-managed inventory, supply chain dynamic SKU performance and optimization method comprising:
using an information technology system including at least one processor and at least one database, the information technology system communicating with a dealer location over a communications network;
defining a service threshold associated with at least one stock keeping unit (SKU) at the dealer location;
receiving at least one inventory count data feed from monitoring the at least one SKU at the dealer location over a predefined time interval;
directing service to the dealer location when the service threshold is met for the at least one SKU at the dealer location; and
processing the at least one inventory count data feed to generate enhanced SKU depth recommendations relative to how often the at least one SKU reaches a service threshold before the desired service interval over a given time period.

2. The method of claim 1 wherein monitoring is performed using radio-frequency identification (RFID) transmitters communicating with the information technology system over the communications network.

3. The method of claim 1, the service threshold comprising:
inventory level, time out of stock, and time period since last servicing event.

4. The method of claim 1 wherein enhanced SKU depth recommendations are based on at least one of the following:
the actual rate that a particular SKU is moving at the dealer location and seasonality.

5. A self-managed inventory, supply chain dynamic SKU performance and optimization system comprising:
a service trigger generator that monitors at least one stock keeping unit (SKU) at a dealer location and creates a service trigger to direct service to the dealer location when an inventory level associated with the at least one SKU at the dealer location reaches a service threshold.

6. The system of claim 5 wherein the service trigger generator is based on time since last service.

7. The system of claim 5 further comprising:
an enhanced SKU depth optimizer that provides SKU depth recommendations based on changes in the inventory level associated with the at least one SKU monitored over a specified period of time.

8. The system of claim 7 wherein the service trigger is a demand based service trigger used to augment one of the following:
a route service trigger and an order service trigger.

9. The system of claim 8 wherein when the service trigger is the route service trigger, the demand based service methodology is utilized in an auxiliary manner to provide an advisory when out of cycle replenishment is required.

10. The system of claim 8 wherein when the service trigger is the route service trigger, the enhanced SKU depth recommendations are utilized to increase the desired service interval thus creating enhanced route service.

11. The system of claim 8 wherein when the service trigger is the order service trigger, the demand based service methodology is utilized in an auxiliary manner to provide an advisory when to prompt the dealer to place an order.

12. The system of claim 8 wherein when the service trigger is the order service trigger, the enhanced SKU depth recommendations are utilized to increase the desired service interval to create enhanced order service.

13. A self-managed inventory, supply chain dynamic SKU performance and optimization system comprising:
at least one inventory count transmitter sending at least one scheduled data feed about at least one stock keeping unit (SKU) at a dealer location; and
an information technology system that processes the at least one scheduled data feed from the at least one inventory count transmitter and provides a service trigger based upon market demand and enhanced SKU depth optimization recommendations based on the processed information.

14. The system of claim 13, wherein the processed information comprises:
inventory movement, inventory history and transmitter characteristics.

15. The system of claim 13 wherein the information technology system comprises:
a recommendations engine containing SKU depth recommendations and at least one service trigger generator.

16. The system of claim 13 wherein the information technology system comprises:
at least one database storing one or more tables containing inventory counts, inventory history and transmitter characteristic data obtained from the at least one inventory count transmitter.

17. The system of claim 13 wherein the at least one inventory count transmitter is an RFID transmitter.

18. The system of claim 13 wherein the information technology system provides recommendation outputs in the form of secure web services.
